(19) United States
(12) Patent Application Publication
(10) Pub. No.: US 2008/0010459 A1
(43) Pub. Date: Jan. 10, 2008

(54) System and method of securing optical media

(75) Inventors: Aaron Knoll, Holtsville, NY (US); Jennifer Kelliher, Bellport, NY (US)

Correspondence Address: Stephen E. Feldman, 7th FL, 12 E. 41st Street, New York, NY, 10017, US

(73) Assignee: Protocall Technologies

(21) Appl. No.: 11/521,126

(22) Filed: Sep. 14, 2006

Related U.S. Application Data
(60) Provisional application No. 60/716,838, filed on Sep. 14, 2005.

(51) Int. Cl. H04L 9/00

(52) U.S. Cl. 713/176

(57) ABSTRACT

The combination of strategic insertion of uniquely generated Digital Watermarks with an on-demand method of manufacturing digital content (Audio CD, Software CD, DVD Video Games, DVD Movies etc.) can be applied in such a way that the content can be forensically tied to the physical media.

### CROSS-REFERENCE TO RELATED APPLICATIONS

This application is based upon and hereby claims priority to U.S. Provisional Patent Ser. No. 60/716,838 filed Sep. 14, 2005 and entitled System and Method for Securing Optical Media, hereby incorporated by reference.

### BACKGROUND OF THE INVENTION

Due to the nature of pre-produced optical media it is impossible to create unique features specific to the point-of-sale and thus impossible to embed covert and overt information in the optical media or the digital files contained on the optical media. It is, however, possible to utilize these features in an On-Demand or One-Off manufacturing process. These unique covert and overt features such as Digital Watermarks; Digital Fingerprints; and embedded and overt serialization, if tied directly into the point-of-purchase, can greatly enhance security of the data stored on the optical media and provide a significant deterrent to piracy.

### FIELD OF THE INVENTION

This invention relates generally to the fields of security, anti-piracy, and copy protection. Moreover, it pertains specifically to the ability to incorporate covert security features such as unique digital watermarking and digital fingerprinting as well as overt security features such as serialization and copy protection with unique optical media creation, to produce a result superior to all prior methods.

### BRIEF SUMMARY OF THE INVENTION

A principal object of the present invention is to provide a method for implementation of unique covert and overt marking technology that has many novel features not offered by the prior art that results in a new forensic security and anti-piracy method which is not apparent, obvious, or suggested, either directly or indirectly by any of the prior art.

An object of the present invention is to provide a method for securing digital content that will overcome the deficiencies of the prior art devices.

Another object of the present invention is to provide a method for securing digital content that will allow the marked material to be traced through the supply chain.

Another object of the present invention is to provide an anti-piracy method that would allow digital products to be forensically identified in the case of suspected theft or piracy.

Another object of the present invention is to provide a method for verification such that Optical Media can easily be detected as being counterfeit.

Another object of the present invention is to provide a method wherein the authenticity and validity of Optical Media can be ascertained.

Another object of the present invention is to provide a method wherein the copyright of digital data files such as Movies and Audio can be ascertained.

Another object of the present invention is to provide a method for securing digital content that is superior to that used by makers of pre-stamped media such that it will give those in the on-demand digital content industry a competitive advantage.

Another object of the present invention is to provide a process that will enable authentication of digital products.

It is intended that any other advantages and objects of the present invention that become apparent or obvious from the detailed description or illustrations contained herein are within the scope of the present invention.

### BRIEF DESCRIPTION THE DRAWING

FIG. 1 is a block diagram showing the network topology;

FIG. 2 is a flow diagram showing the steps to secure data onto optical media; and

FIG. 3 is a block diagram showing a breakdown of EDC data.

### DETAILED DESCRIPTION OF THE INVENTION

The present invention combines a direct-to-consumer, one-off, digital content manufacturing process with industry standard Digital Watermarking technologies and proprietary Digital Fingerprinting and serialization techniques to create a new method for securing optical media and the files that reside on the optical media.

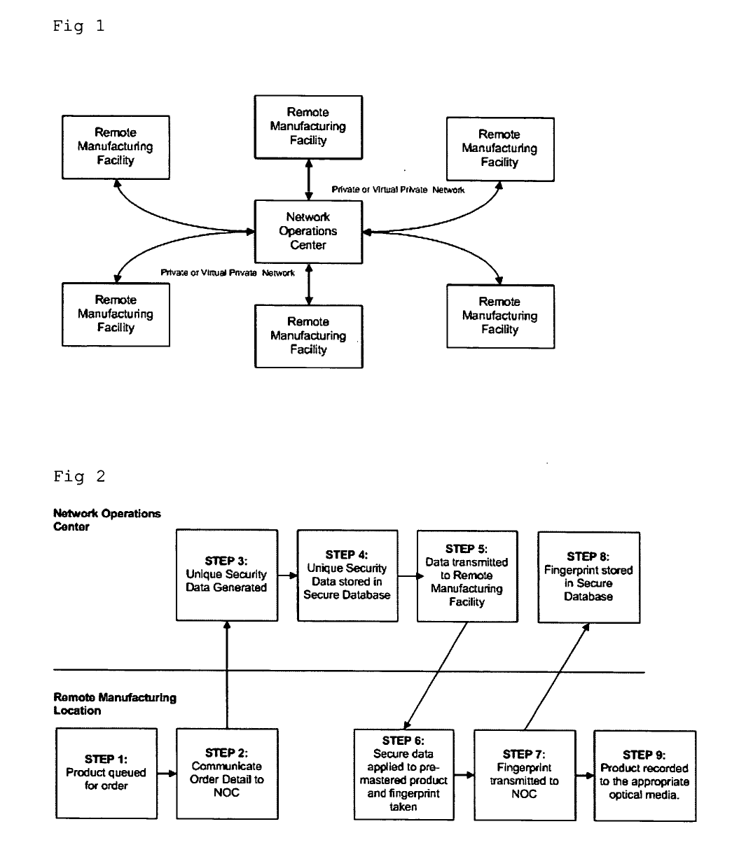

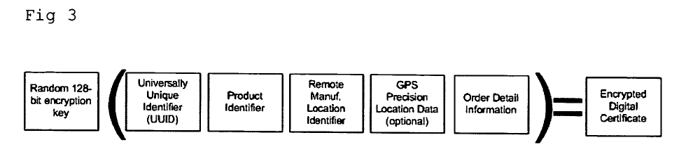

This invention involves a multi-tiered security implementation that is comprised of the following data:
1. ISO/IEC 11578:1996 128-bit Compliant Universally Unique Identifier (UUID) generated for each piece of Optical Media for unique serialization. The UUID is utilized overtly by being physically printed on the Optical Media as well as being covertly stored in the Encoded Digital Certificate. The UUID is also stored on a secure server
2. Unique Encoded Digital Certificate (EDC) containing unique product manufacturing and tracking information for each product produced.
3. Digital Fingerprint of each piece of Optical Media.
   The following physical interconnected nodes are used to securely manage and distribute this data. (see FIG. 1 for network topology):
1. A plurality of Remote Optical Media Manufacturing Facilities. These facilities may reside in a Retail Store, Warehouse, Kiosk, or other non-secured area. These facilities have the capability of producing Product on Optical Media in a one-off or on-demand fashion such as (but not limited to) DVD Movies, CD Audio, and Computer Software.
2. Secure Network Operation Center
3. Secured Private or Virtual Private Network
   To secure the data on the Optical Media, a multi-step process is used to facilitate secure production. (See FIG. 2)
   Step 1: The Remote Manufacturing Facility creates order.
   Step 2: Remote Manufacturing Facility transmits order detail to Network Operations Center (NOC) over Secure Private or Virtual Private Network.
   Step 3: NOC Security Server generates Universally Unique Identifier (UUID) and Encoded Digital Certificate (EDC). The data that resides in the EDC is shown in FIG. 3. EDC is encrypted with AES encryption using randomly generated 128-bit key (known as the Order Key) and signed using the NOCs secret private key for authenticity. The UUID, EDC, and Order Key are stored in the NOCs Secure Database Server. SHA256 Hash values are taken of each component and stored as well.
   Step 5: UUID and encrypted EDC are transmitted to Remote Manufacturing Facility.
   Step 6: UUID and encrypted EDC are applied to pre-mastered Optical Media image using one of the many industry standard Digital Watermarking techniques. This technique will vary by product type; for example, a DVD Video Disc will the watermark directly embedded into the video stream while a Software CD can have the watermark stored in an unobtrusive area of the file system. In addition, the UUID is stored in a machine-readable area of the Optical Media such as the Table of Contents (TOC) or some other file header area. Digital Fingerprint (SHA256 Hash) is taken of the finished pre-mastered image for authenticity.
   Step 7: Digital Fingerprint is transmitted to NOC over the Secure Private or Virtual Private Network.
   Step 8: Digital Fingerprint is stored in NOCs Secure Database Server
   Step 9: The Product is recorded to the appropriate Optical Media. The overt security measure of imprinting the UUID on the physical media is completed at this time.
   Once this security data is integrated into the Optical Media there are several methods to recover said data so that authenticity can be verified:
1. The UUID can be read off of the Table of Contents without need of special software. This UUID can by optically matched with the UUID imprinted on the physical media and basic verification completed.
2. Specialized software can be used to read the Digital Watermarks that reside on the Optical Media. These Watermarks can be decrypted using a connection to the NOC, allowing all of the Encoded Digital Certificate data to be retrieved.
3. In the case of Computer Software, CD Audio, and DVD video, Digital Watermarks that survive copying and data compression can be utilized to ensure that if data is removed from the Optical Media the Watermark travels with it. In this way, if copyrighted material is found its source can be ascertained through analyzing the Encoded Digital Certificate data.
   It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What is claimed is:

1. A method for creating a cryptographically unique and securely signed digital certificate and computer-generated universally unique identifier that is specific to an individual digital product comprising the steps of:
(a) creating an order;
(b) transmitting the order;
(c) generating a unique identifier and a digital certificate;
(d) transmitting the unique identifier and the digital certificate;
(e) applying the unique identifier and the digital certificate to the order; and
(f) recording the order with the applied unique identifier and digital certificate onto an optical media.

2. The method of claim 1 wherein the digital certificate and universally unique identifier are stored in a secured remote database location for future authentication.

3. The method of claim 1 further comprising the step of:
uniquely digitally marking and verifying an optical media video product by (1) applying a digital certificate in a covert fashion to a pre-mastered optical media video product utilizing one of a plurality of industry standard digital watermarking techniques directly into the mpeg video stream; (2) storing a computer-generated universally unique identifier in an overt area of the pre-mastered optical media product; and (3) taking a secure hash value of the final product.

4. The method of claim 1 comprising the steps of:
uniquely digitally marking and verifying an optical media audio product by (1) applying a digital certificate in a covert fashion to a pre-mastered optical media audio product utilizing one of a plurality of industry standard digital watermarking techniques directly into the audio stream; (2) storing a computer-generated universally unique identifier in an overt area of the pre-mastered optical media product; (c) taking a secure hash value of the final product.

5. The method of claim 1 comprising the steps of:
uniquely digitally marking and verifying an optical media audio product by (1) applying a digital certificate in a covert fashion to the pre-mastered optical media computer software product utilizing one of a plurality of industry standard digital watermarking techniques; (2) storing a computer-generated universally unique identifier in an overt area of the pre-mastered optical media product; (3) taking a secure hash value of the final product.

6. The method of claim 3 whereby the digital certificate can be extracted from a video stream of the optical media.

7. The method of claim 6 whereby the extracted digital certificate can be used to verify the authenticity of the optical media by comparing the extracted digital watermark with an archived version.

8. The method of claim 4 whereby the digital certificate can be extracted from an audio stream of the optical media.

9. The method of claim 8 whereby the extracted digital certificate can be used to verify the authenticity of the optical media by comparing the extracted digital watermark with an archived version.

10. The method of claim 5 where the digital certificate can be extracted from the optical media software product.

11. The method of claim 10 where the extracted digital certificate can be used to verify the authenticity of the optical media software product by comparing the extracted digital watermark with an archived version.

12. The method of claim 3 where the universally unique identifier can be extracted from an overt area of the optical media video product.

13. The method of claim 12 where the extracted universally unique identifier can be used to verify the authenticity of the optical media video product by comparing the extracted universally unique identifier with an archived version.

14. The method of claim 4 where the universally unique identifier can be extracted from an overt area of the optical media audio product.

15. The method of claim 14 where the extracted universally unique identifier can be used to verify the authenticity of the optical media audio product by comparing the extracted digital watermark with an archived version.

16. The method of claim 5 universally unique identifier can be extracted from an overt area of the optical media product.

17. The method of claim 10 where the extracted universally unique identifier can be used to verify the authenticity of the optical media software product by comparing the extracted digital watermark with an archived version.

18. The method of claim 1 further comprising the step of:
verifying suspected pirated digital media content that can be found on a plurality of internet areas by (1) scanning for an embedded digital certificate within the data stream and (2) comparing any found certificate with a remote database of known digital certificates to trace the product back through the supply chain.

19. A system for creating a cryptographically unique and securely signed digital certificate and computer-generated universally unique identifier that is specific to an individual digital product comprising:
(a) creating means for creating an order;
(b) first transmitting means for transmitting the order;
(c) generating means for generating a unique identifier and a digital certificate;
(d) second transmitting means for transmitting the unique identifier and the digital certificate;
(e) applying means for applying the unique identifier and the digital certificate to the order; and
(f) recording means for recording the order, the unique identifier and the digital certificate onto an optical media.
